(19) United States
(12) Patent Application Publication
(10) Pub. No.: US 2008/0102336 A1
(43) Pub. Date: May 1, 2008

(54) Fuel Cell System With a Metering Unit

(76) Inventors: Willi Strohl, Beilstein (DE); Ulrich Gottwick, Stuttgart (DE)

Correspondence Address: STRICKER, STRICKER & STENBY, 103 East Neck Road, Huntington, NY, 11743, US

(21) Appl. No.: 11/722,803

(22) PCT Filed: Feb. 9, 2006
(86) PCT No.: PCT/EP06/50818

§ 371 Date: Jun. 26, 2007

(30) Foreign Application Priority Data
Nov. 2, 2005 (DE) 102005006355.1

(51) Int. Cl. H01M 8/00; H01M 4/06

(52) U.S. Cl. 429/27; 429/34

(57) ABSTRACT

The invention relates to a fuel cell system comprising a fuel cell unit (1) and a metering unit for metering a quantity of a substance for at least one electrode (3, 5), said metering unit comprising at least two metering elements (16, 17) that are connected in parallel. Said system simplifies the control of the substance quantity to be metered and permits in particular a comparatively sensitive and/or relatively rapid control of the substance quantity to be metered or has the lowest possible internal consumption. The system should also be capable of diagnosing faults, i.e. should recognise a development of pressure ratios that could damage the system. To achieve this, the first metering element (16) is configured as a control element for controlling the flow cross-section of the second metering element (17) by means of a pneumatic coupling.

The present invention relates to a fuel cell system with a fuel cell unit which includes a metering unit for metering a quantity of a substance for at least one electrode, according to the preamble of claim 1.

### RELATED ART

Of all of the alternative drive concepts for motor vehicles, ships or the like, and as power stations, the greatest amount of attention is currently directed toward systems operated using fuel cells. These systems typically include PEM fuel cells (PEM: polymer electrolyte membrane), which are often operated using hydrogen and air as the fuel. In addition, other fuel cell systems are already in use.

The vehicle can be fueled at a filling station with hydrogen, which is stored in the motor vehicle. Or, e.g., the hydrogen is produced directly “on board” as needed, in an upstream reforming stage, from fuels such as methanol, methane or diesel, and it is then consumed accordingly.

In fuel cell systems of this type, it is therefore necessary to meter a large quantity of substance flows in a flexible yet highly accurate manner. This applies for liquid components, such as water and fuels, and for gaseous media, such as air, hydrogen, and the like.

To reduce pressure fluctuations resulting from the operation of pumps and/or compressors, it is already known, e.g., to use two series-connected control valves in a substance branch. Series-connected valves are not suited, however, to metering a quantity of substance requested by the fuel cell or fuel cell stack in response to dynamic changes in the relatively broad performance range that is required, or to automatically align the pressure of the anode substance flow with the pressure of the cathode substance flow.

With many fuel cell systems, particularly PEM fuel cells, it is necessary, however, to continually align the anode pressure with the cathode pressure, in order to reliably prevent damage to the relatively pressure-sensitive membrane. A pressure adjustment of this type should optimally take place simultaneously or quasi-simultaneously, i.e., a pressure adjustment should take place within a time frame of approximately 20 ms. Otherwise, the membrane could become irreversibly damaged.

A pressure adjustment of this type is very demanding, e.g., in vehicle applications characterized by very high dynamics, particularly passing maneuvers or the like.

In prototypes, hydrogen injection valves connected in parallel, i.e., hydrogen gas injectors (HGI), are used, e.g., to meter hydrogen for a fuel cell system. The injection valves are controlled via an electronic control device that registers the pressures on the cathode side and the anode side, so that the same pressure level results on the anode side of the fuel cell stack—within the permissible pressure differential—as on the cathode side, despite constant consumption. Provided the anode-side pressure is kept at the same level as the pressure on the cathode side, it is automatically ensured that a sufficient quantity of hydrogen will be supplied, since consumption automatically adjusts to the demand via the passage of protons through the fuel cell membrane, within certain limits.

A disadvantage, however, is the fact that, to cover the maximum quantity consumed and the dynamics required for the system, 4 to 6 individual injection valves are required for a typical fuel cell vehicle application with, e.g., approximately 75 kW.

A correspondingly greater number of injection valves is required for higher outputs. The control of the numerous injection valves becomes relatively complex as a result.

It is also disadvantageous that injection valves of this type require approximately 1 A of current for the maximum quantity of substance or in the wide-open state. As a result, given a large number of valves, a correspondingly complex control device is required, the energy consumed by the metering is relatively high, and the parasitic loads are relatively high.

### OBJECT AND ADVANTAGES OF THE INVENTION

The object of the present invention is to provide a fuel cell system with a fuel cell unit, with a metering unit for metering a quantity of substance for at least one electrode; the metering unit includes at least two metering elements, which are connected in parallel;

the fuel cell system simplifies the control of the quantity of substance to be metered and, in particular, makes possible a relatively precise and/or rapid control of the quantity of substance to be metered, and has the lowest possible intrinsic consumption. In particular, the system should also be capable of diagnosing faults, i.e., it should be possible to detect—as a fault—the development of pressure conditions that could be detrimental or harmful to the system.

This object is attained, based on a fuel cell system of the type described initially, via the characterizing features of claim 1. Advantageous embodiments and refinements of the present invention are made possible by the measures described in the subclaims.

Accordingly, a fuel cell system according to the present invention is characterized by the fact that the first metering element is designed as a control element for controlling the flow cross-section of the second dosing element.

It is particularly advantageous that, by using the present invention, the control of the quantity of substance to be metered has been simplified, and, in particular, that it is controllable using a small amount of electrical energy or electrical output. This can be realized, in particular, across the entire range of the quantity of substance to be metered. According to the present invention and compared with the related art, this results, e.g., in an advantageous reduction in electrical energy for metering.

In addition, the fact that the quantity of substance to be metered by the first metering element can be metered particularly accurately and with relatively narrow tolerances can be utilized particularly advantageously according to the present invention. As a result, the entire quantity of substance to be metered can be controlled accurately using the first metering element. The quantity of substance to be metered can therefore be adjusted exactly.

The first metering element advantageously has a relatively small quantity of substance that can flow through, and the second metering element has a relatively large quantity of substance that can flow through. To this end, in a variant of the present invention, e.g., a lower pressure is applied to the first metering element compared with the pressure applied to the second metering element. A type of amplifier principle can therefore be realized, which makes it possible to meter the quantity of substance into the fuel cell unit relatively quickly and across a relatively large range. This is particularly advantageous with vehicle applications with relatively high dynamics.

It is also feasible to provide—in addition to the inventive control and/or coupling—an electronic control and/or coupling between the first metering element and the second metering element. For example, an electronic control unit could control and/or change the flow cross-section(s) of the first and/or second metering element, and/or adjust the quantity of substance to flow through or to be metered to meet the demand of the fuel cell unit.

A pneumatic coupling device for coupling the operation of at least the two metering elements is advantageously provided between the first metering element and the second metering element. This makes it possible to attain an advantageous dependence between the two flow cross-sections and, therefore, the two sub-quantities of substance to be metered. With a pneumatic coupling device, it is particularly advantageous that the control does not require any additional energy.

In contrast, with the pneumatic coupling device, it is also advantageous that, with the substance—which is generally a fluid, and a gas in particular—the coupling can be realized synergistically using the substance and/or fuel to be metered. As a result, the implementation of the present invention can be advantageously simplified, in terms of its design and regulation.

In a preferred embodiment of the present invention, a maximum flow cross-section of the first metering element is considerably smaller than a maximum flow cross-section of the second metering element. For example, the maximum flow cross-section of the first metering element is smaller by a factor of 3, 10, 100 or 1000 than a maximum flow cross-section of the second metering element.

The fact that the maximum flow cross-sections of the metering elements differ makes it possible, in particular—due to and exclusively in combination with the parallel connection of the metering elements—to implement very high dynamics in terms of the quantity of substance that can be metered, over a wide range of the volumetric flow of substance to be metered. This is a significant advantage over the related art, with vehicle applications in particular.

For example, in the upper performance range and/or in the maximum range of volumetric flow of substance, the demand required by the fuel cell unit is essentially covered by the second metering element with the relatively large maximum flow cross-section. Optionally, the first metering element can meter an additional quantity of substance to the fuel cell unit. It is also feasible, however, that, given a maximum demand by the fuel cell unit, the first metering element makes no contribution or a less relevant contribution to the quantity of substance to be metered.

It can also be attained according to the present invention that a relatively exact metering of the quantity of substance can be implemented over a particularly wide range of the quantity of substance. For example, relatively large, changeable flow cross-sections generally have large tolerances in terms of the quantity of substance flowing through. In contrast, relatively small, changeable flow cross-sections generally have narrow tolerances in terms of the quantity of substance and/or the volumetric flow that is flowing through.

According to the present invention, a tolerance that is relatively narrow overall with regard for the quantity of substance and/or the volumetric flow of substance across the entire range can be attained via the interaction and/or addition of the quantities of substance flowing through the two metering elements, which are to be directed together to the electrode of the fuel cell unit. The narrow tolerance of the first metering element can be used, advantageously, to compensate the relatively large tolerance of the second metering element. Accordingly, the accuracy of the metering is clearly improved over the entire range of the quantity of substance to be metered, compared with the related art.

In a preferred embedment of the present invention, the coupling device includes at least two pressure chambers, which are separated from each other via a partition wall. For example, the pressure chambers are part of the parallel substance branches and/or the parallel lines in which the two metering elements are located.

Advantageously, the partition wall is designed to be adjustable, and displaceable in particular. This advantageously allows, e.g., pressure fluctuations to be transferred pneumatically from one chamber to the other chamber. The partition wall is advantageously designed as a piston in a cylinder or the like.

The partition wall is preferably designed, in particular, as a flexible and/or stretchable membrane. Using this variant of the present invention, a particularly simple and effective pneumatic coupling of the two metering elements can be realized. The membrane is preferably designed such that it is displaceable at least perpendicularly to the membrane surface.

In a particular refinement of the present invention, a displacement of the partition wall, particularly perpendicular to the surface of the partition wall or membrane, changes the flow cross-section of one of the metering elements, particularly the flow cross-section of the second metering element. Using this measure, a pneumatic coupling of the two metering elements and, in particular, the control of the flow cross-section of the second metering element using the first metering element is realizable in a particularly elegant manner.

Advantageously at least one reset device, e.g., a spring, a weight, or the like, is provided, which advantageously makes it possible to displace or reset the partition wall to a resting position. This ensures that, e.g., a defined starting state of the coupling device and/or metering unit is provided. In the starting state or resting state of the metering unit and/or coupling device, for example, it is provided that one of the metering elements, preferably the second metering element, is closed completely. The reset unit is preferably coupled and/or connected—preferably mechanically—with the valve body of the related metering element and/or valve, so that the valve body rests on the related valve seat and completely closes the flow cross-section of the corresponding valve.

A metering element designed as a valve can have a valve body with a shape that is conical or spherical or the like. A type of orifice that enables the flow cross-section to be changed is also feasible.

Advantageously, at least one throttle element for changing the pressure is located in one of the metering elements and in parallel with the other metering element. This advantageously ensures that the pressure in this branch and/or in the corresponding pressure chamber can advantageously build up or dissipate such that an advantageous adaptation of the metering unit to the entire range of the quantity of substance to be metered into the fuel cell unit can be carried out. In particular, this allows the dynamics of the system and/or the pressure maximum to be adjusted in an advantageous manner.

In an advantageous variant of the present invention, at least one control unit for controlling the first and/or second metering element is provided. Optionally, a pneumatic control unit can be implemented, which is designed, e.g., as a pneumatic reference unit for comparing the cathode pressure with the anode pressure. For example, using a changeable adjusting element that is pneumatically connected with the cathode and the anode of the fuel cell unit, it is possible to realize a comparison of the cathode pressure with the anode pressure and/or a control of the metering element(s). An electronic control unit for controlling the metering element(s) is advantageously provided.

In a preferred refinement of the present invention, at least one first pressure sensor is provided for sensing the cathode pressure, and a second pressure sensor is provided for sensing the anode pressure. The pressure sensors preferably generate electrical signals and transmit them to an electronic comparator and/or control unit.

There are also pressure differential sensors that measure Δp=p_{A}−p_{K}. The present invention can also be advantageously realized using a pressure sensor for sensing p_{A}, and a Δp sensor.

Advantageously, the control unit is designed to compare the cathode pressure with the anode pressure.

In a particular embodiment of the present invention, the cathode pressure is the guide variable of the control unit. This means the anode pressure is adjusted based on cathode pressure. The cathode pressure is measured or estimated based on compressor variables and throttle elements. This pressure is used as the setpoint value for regulating the anode pressure.

Preferably, at least the first metering element is designed as a gas injection valve. It has been shown in practice that a first metering element designed as a gas injection valve, which advantageously and preferably controls the second metering element, is particularly effective.

The throttle element is preferably designed as a gas injection valve. A gas injection valve designed as a throttle element is preferably realized to be open in the de-energized state.

### DETAILED DESCRIPTION OF THE EXEMPLARY EMBODIMENT

An exemplary embodiment of the present invention is presented in the drawing and is described in greater detail below with reference to the figures.

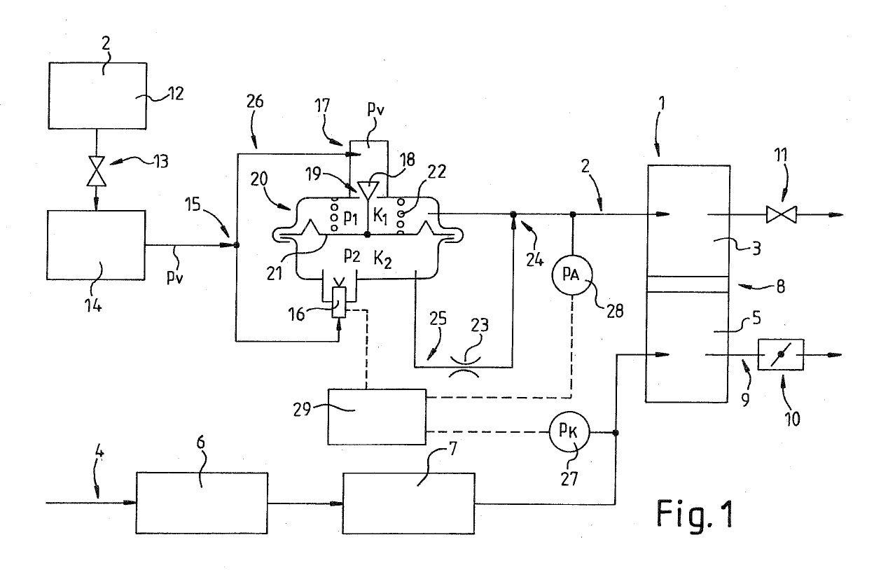

FIG. 1 shows a schematic diagram of an inventive fuel cell system, and

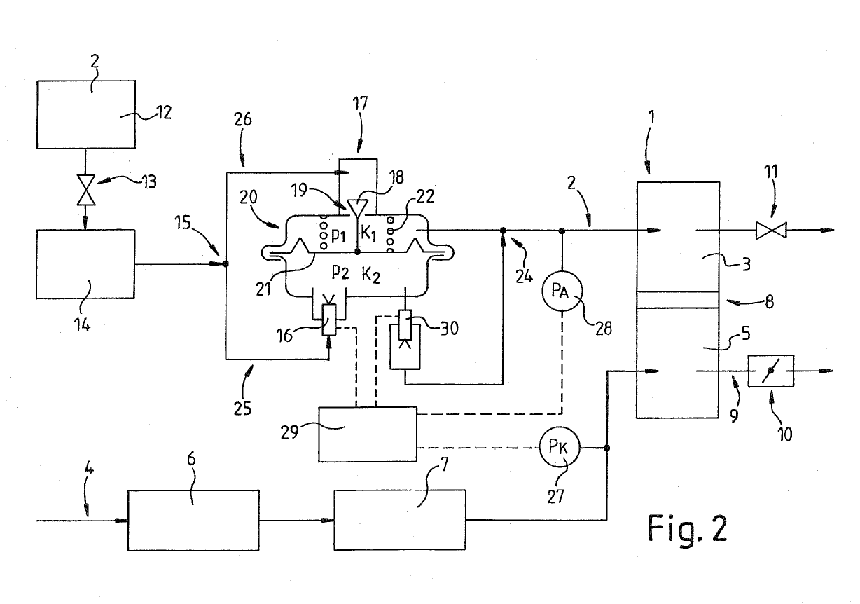

FIG. 2 shows a schematic diagram of a second inventive fuel cell system.

In FIG. 1, a fuel cell stack 1 is supplied with hydrogen 2 for an anode 3, and it is supplied with air 4 for a cathode 5.

Air 4 is compressed using a compressor 6, then it is wetted with water using a humidifier 7, so that a membrane 8 of fuel cell stack 1 does not dry out nor become too wet.

Fuel cell stack 1 includes an outlet 9, at which a throttle 10 for adjusting the outflowing quantity and/or for generating aerodynamic pressure is provided. A valve 11 is provided on the anode side of fuel cell stack 1, which is closed in normal operation and is opened, e.g., to rinse anode 3. The latter is used, in particular, to rinse nitrogen, etc., that may have accumulated on the anode side.

In this embodiment, hydrogen 2 is stored in a high-pressure tank 12, which is closeable using a shutoff valve 13. Hydrogen 2 is stored in high-pressure tank 12, e.g., at 350 bar or 700 bar. As an alternative to high-pressure tank 12, tank 12 can also be designed as a low-pressure tank, e.g., as a metal-hydride reservoir or as intermediate storage for a hydrogen reformate, etc.

A pressure reducer 14 is preferably provided for reducing the storage pressure of high-pressure tank 12. An upstream pressure p_{V} is present in the direction of flow of hydrogen 2 after pressure reducer 14. After branch 15, hydrogen 2 is directed to a first metering element 16 and to a second metering element 17. Metering element 16 is designed, e.g., as a switching valve with an open/close function, or as an HGI 16 (hydrogen gas injector). Metering element 17 is designed, e.g., as a valve 17 with a valve body 18, particularly a cone-shaped valve body 18 that closes or opens a valve seat 19.

Valves 16 and 17 comprise an assembly 20 designed as a pressure reduction valve 20. Assembly 20 includes two chambers K₁ and K₂—in which pressures p₁ and p₂ are present—which are separated by a membrane 21. Membrane 21 is mechanically coupled with valve body 18, so that a deflection of membrane 21, particularly perpendicularly to the membrane surface, brings about a displacement or closing and/or opening of valve seat 19.

In addition, a spring 22 is provided in chamber K, which presses against a housing of assembly 20 and against membrane 21. Spring 22 therefore brings about a preload of valve 17, so that valve 17 is closed at equilibrium pressure, i.e., when p₁=p₂. Membrane 21 is fixed securely in position and as pressure-tightly as possible, e.g., by crimping two housing halves of assembly 20.

An outflow throttle 23 is located downstream of chamber K₂ in the direction of flow. A second branch 24 is provided downstream of chamber K₁ and outflow throttle 23, in the direction of flow, so that a flow path 25 is connected in parallel with flow path 26. Metering element 16, chamber K₂, and outflow throttle 23 are located in flow path 25, and valve 17, spring 22, and chamber K₂ are located in flow path 26. Metering element 16 and outflow throttle 23 are connected in series in flow path 25. The two flow paths 25, 26 are defined by the two branches 15, 24.

In addition, a pressure sensor 27 for determining cathode pressure p_{K} is provided in the cathode or air path, and a sensor 28 for determining anode pressure p_{A} is provided in the anode or hydrogen path. Both sensors 27, 28 are connected via a control unit 29 or an electronic control device for regulation purposes. Control unit 29 is designed to compare pressures p_{K} and p_{A}; p_{K} is used as a guide variable for p_{A}.

Control unit 29 is also connected with metering element 16 or HGI 16 for regulation purposes, thereby enabling the flow cross section or the quantity of hydrogen 2 metered by metering element 16 to be controlled by control unit 29. Pressure p₂ in chamber K₂ is defined by the quantity of hydrogen 2 metered by HGI 16. A change in pressure p₂ and/or a change in pressure p₁ brings about a corresponding deflection of membrane 21, so that a flow cross-section of valve 17 of valve seat 19 is changed and is controlled by HGI 16. Valve 16 and valve 17 are therefore pneumatically coupled.

In the exemplary embodiment shown in FIG. 2, and in contrast to the embodiment shown in FIG. 1, a second injection valve 30 and a second HGI 30 are provided, in place of outflow throttle 23 shown in FIG. 1. Second HGI 30 shown in FIG. 2 is preferably switched open in the de-energized state.

Advantageously, control unit 29 regulates anode pressure p_{A} with the aid of guide variable p_{K} such that p_{A} essentially corresponds to p_{K}. To this end, metering element 16 or HGI 16 is advantageously controlled via pulsing.

The flow cross-section of HGI 16 is much smaller than the flow cross-section of valve seat 16 or valve 17. As a result, a much greater quantity of substance can flow through flow path 26 than through flow path 25.

HGI 16 is characterized by particularly high accuracy and a relatively good capability to meter the quantity of substance flowing through flow path 25, thereby enabling pressure p₂ in chamber K₂ to be adjusted very exactly. The deflection of membrane 21 can therefore be adjusted very exactly, thereby enabling the relatively large quantity of hydrogen 2 flowing through flow path 26 to be adjusted relatively exactly. In addition, assembly 20 functions as an amplifier or multiplier via the control of a relatively large quantity of substance in flow path 26 with the aid of a relatively small quantity in flow path 25.

Membrane 21 is in force equilibrium when the differential pressure of chambers K₁ and K₂, i.e., Δp=p₂−p₁, becomes equal to the spring force divided by the effective surface of the membrane plus the force acting on valve body 18 via differential pressure Δp_{V}=p_{V}−p₁. The spring force is generated by spring 22.

Valve 17 is designed such that it is open in this state of equilibrium—or such that it opens when this state of equilibrium is reached—and hydrogen 2 is supplied to fuel cell stack 1 in accordance with the cross-section of the valve opening that has been exposed, via chamber K₁.

Chamber K₂ is supplied with hydrogen 2 by pressure reducer 14 via HGI 16. Hydrogen 2 then flows via outflow throttle 23 to the anode side of fuel cell stack 1. Via an advantageous dimensioning or adjustment/calibration of outflow throttle 23, pressure P2 in chamber K₂ can be adjusted, at least within certain limits, via the cycle ratio of the control of HGI 16, i.e., via the quantity flowing into chamber K₂. HGI 16, together with outflow throttle 23, is a pressure divider circuit, in the case of which pressure p₂ between HGI 16 and throttle 23, i.e., in chamber K₂, depends on the quantity of hydrogen flowing through.

In the state of equilibrium, pressure P1 also results in chamber K₁ according to the relationship depicted above. This means that pressure p₁ and anode pressure p_{A} change via the cycling ratio; p₁ essentially corresponds to p_{A}. Control unit 29 is advantageously programmed such that it strives to adjust pressure p_{A} to a setpoint pressure p_{K} by changing the cycle ratio of HGI 16.

The control action will be described in greater detail below using the description of disturbances of the equilibration state.

### Case A) Cathode-side Setpoint Pressure p_{K} Increases:

Pressure p₁ is now less than setpoint pressure p_{K}. Control unit 29 cycles HGI 16 open again, and p₂ increases. Higher pressure p₂ in chamber K₂ causes membrane 21 to deflect such that valve body 18 opens and exposes a greater cross-section. More hydrogen 2 now flows into chamber K₁, and p₁ increases until the state of equilibrium has been reached again, i.e., until p₁ or p_{A}=p_{K}.

### Case B) Cathode-side Setpoint Pressure p_{K} Decreases:

Pressure p₁ is now greater than setpoint pressure p_{K} Control unit 29 cycles HGI 16 open to a lesser extent or closes it entirely, so that p₂ decreases. Lower pressure p₂ in chamber K₂ causes membrane 21 to deflect such that valve body 18 exposes a smaller opening cross-section or it closes entirely. A smaller quantity of hydrogen 2 now flows into chamber K₁, and p₁ reduces until the state of equilibrium has been reached again.

### Case C) The Quantity of Hydrogen Consumed by Fuel Cell Stack 1 Increases:

Pressure p₁ drops initially, since a quantity of hydrogen 2 that is sufficient to cover the consumption by fuel cell stack 1 can no longer flow through valve 16. Lower pressure p₁ in chamber K₁ causes membrane 21 to deflect such that valve body 18 exposes a larger opening cross-section. A greater quantity of hydrogen 2 now flows into chamber K₁, and p₁ increases until the state of equilibrium has been reached again. The process is further accelerated by the fact that HGI 16 starts to cycle again, as described in Case A), above, thereby moving membrane 21 in the same direction.

### Case D) The Quantity Consumed by Fuel Cell Stack 1 Decreases:

Pressure p₁ increases, since the quantity of hydrogen 2 that flows through valve 17 is greater than the quantity consumed by fuel cell stack 1. Higher pressure p₁ in chamber K₁ causes membrane 21 to deflect such that valve body 18 exposes a smaller opening cross-section or it closes entirely. A smaller quantity of hydrogen 2—or no hydrogen 2 at all—now flows into chamber K₁, and p₁ decreases until the state of equilibrium has been reached again. The process is further accelerated by the fact that the cycling of HGI 16 as described in Case B), above, is reduced, or the HGI closes entirely, thereby moving membrane 21 in the same direction.

### Case E) The Quantity Consumed by Fuel Cell Stack 1 is within the Range of the Quantity Injected via HGI 16:

Differential pressure p₂−p₁ becomes less than the spring force, and spring 22 closes valve 17 and valve seat 19. Regulation is now carried out by control unit 29, with valve 17 closed, only via the cycled control of HGI 16, thereby regulating p_{A} to setpoint value p_{K}. This means flow path 26 is closed completely, and only flow path 25 allows hydrogen 2 to flow through.

### Case F) The Quantity Consumed by the Fuel Cell Stack becomes Zero, e.g., at Shut-off:

Control unit 29 does not trigger HGI 16. Therefore, nothing flows into chamber K₂. Pressures p₁, p₂ are equalized in chambers K₁ and K₂ via throttle 23. This means that differential pressure p₂−p₁ becomes zero, and only the spring force of spring 22 acts on membrane 21. This spring force closes valve 17 and holds it shut until fuel cell stack 1 requests more hydrogen 2.

It is basically advantageous when upstream pressure p_{V}—which is present at the outlet of pressure reduction valve 20 or assembly 20, and which is present in front of valve 17 and at inlet of HGI 16—is greater than the maximum anode pressure p_{A} to be regulated. Typically, p_{V} is in a range of 4 to 15 bar, and p_{K} and p_{A} are approximately in the range of 1 to approximately 3 bar.

The seat surface of valve seat 19 should be smaller than the effective surface of the membrane; advantageously it is considerably smaller. In particular, the maximum surface area exposed by valve 17 should be large enough that, given a minimal upstream pressure p_{V} and a maximum pressure in fuel cell stack 1, the maximum consumption quantity required and the required control dynamics can be ensured.

Advantageously, the cross-section of outflow throttle 23 should be matched to the maximum cross-section exposed by HGI 16 such that the pressure divider circuit of HGI 16 and throttle 23 can advantageously cover the entire pressure range that occurs in fuel cell stack 1.

There is no restriction on the geometry of valve seat 19 or valve body 18. For example, it is also possible to realize ball valves, flat-seat valves, slit valves, and other designs.

Membrane 21 can be composed of any flexible material, and it should meet the requirements for compressive strength, resistance to gas, and seal integrity, e.g., metal, plastic, or plastic-coated cloth. Since the same gas flows around both sides of chambers K₁ and K₂, it is possible to attain relatively great permeation through the membrane material up to dimensions of approximately 1/10 of the mass flows through injection valve 16.

As an alternative to cycled switching valve 16 or HGI 16, a proportional valve 16 or the like can be used, with correspondingly small mass flows.

In general, other operating gasses or fluids can be used instead of hydrogen 2. Given a relatively great positive or negative Joule-Thomson effect, it is advantageous to provide advantageous heat dissipation or heat supply, given that relatively great temperature changes take place when gas expands in chamber K₁; this can be accomplished in a not-shown manner using a heat exchanger or the like.

Basically, according to the present invention, anode-side pressure p_{A} can be compensated by deliberately supplying hydrogen 2 or the like under cathode-side pressure p_{K}, which is the guide variable. By adjusting anode-side pressure p_{A}, it is ensured—even when consumption is constant, in particular—that the quantity of substance supplied to fuel cell stack 1 is always exactly the quantity that fuel cell stack 1 consumes. The metering therefore results nearly automatically, according to the present invention, from the supply and holding constant of anode-side pressure p_{A}.

In particular, according to the present invention, it is particularly advantageous that a cost-favorable solution can be attained using only one electronically controlled valve 16, even for systems with high output and high requirements on dynamics. The requirements on the control device or control unit 29 remain constant, even when the quantities of substances are high. For example, a maximum of 1 A is required for control in the exemplary embodiment described above and when only one HGI 16 is used. This also reduces costs considerably compared with the related art.

In addition, small quantities, e.g., during idling or partial-load range, can be injected with the same accuracy as with the related art, since direct metering results here via HGI 16.

In addition, the system provided according to the present invention is fully capable of diagnosing faults, since faults in the system can be detected immediately by determining pressures p_{A} and p_{K} and identifying a disadvantageous deviation. Metering element 16 or HGI is preferably designed to be closed in the de-energized state, thereby ensuring a high level of safety if there are faults in the composite system.

What is claimed is:

1. A fuel cell system with a fuel cell unit (1) and a metering unit (6, 16, 17) for metering a quantity of a substance for at least one electrode (3, 5); the metering unit includes at least two metering elements (16, 17) connected in parallel,
wherein
the first metering element (16) is designed as a control element (16) for controlling the flow cross-section of the second metering element (17).

2. The fuel cell system as recited in claim 1,
wherein
a pneumatic coupling device (21, K₁, K₂) is provided between the first metering element (16) and the second metering element (17) for coupling the operation of at least the two metering elements (16, 17).

3. The fuel cell system as recited in claim 1,
wherein
a maximum flow cross-section of the first metering element (16) is considerably smaller than a maximum flow cross-section of the second metering element (17).

4. The fuel cell system as recited in claim 1,
wherein
the coupling device (21) includes at least two pressure chambers (K₁, K₂), which are separated from each other by a partition wall (21).

5. The fuel cell system as recited in claim 1,
wherein
the partition wall (21) is designed as a membrane (21).

6. The fuel cell system as recited in claim 1,
wherein
adjusting the partition wall (21) changes the flow cross-section of the second metering element (17).

7. The fuel cell system as recited in claim 1,
wherein
at least one throttle element (23, 30) for changing the pressure is installed in series with one of the metering elements (16) and in parallel with the other metering element (17).

8. The fuel cell system as recited in claim 1,
wherein
a control unit (29) for controlling the first metering unit (16) is provided.

9. The fuel cell system as recited in claim 1,
wherein
at least one first pressure sensor (27) is provided for sensing the cathode pressure, and a second pressure sensor (28) is provided for sensing the anode pressure.

10. The fuel cell system as recited in claim 1,
wherein
the control unit (29) is designed to compare the cathode pressure with the anode pressure.

11. The fuel cell system as recited in claim 1,
wherein
the cathode pressure is designed as guide variable of the control unit (29).

12. The fuel cell system as recited in claim 1,
wherein
the first metering element (16) is designed as a gas injection valve (16).
